(19) United States
(12) Patent Application Publication
(10) Pub. No.: US 2008/0197576 A1
(43) Pub. Date: Aug. 21, 2008

(54) Joint Materials and Configurations

(76) Inventor: John T. Trout, Minneapolis, MN (US)

Correspondence Address: VIDAS, ARRETT & STEINKRAUS, P.A., SUITE 400, 6640 SHADY OAK ROAD, EDEN PRAIRIE, MN, 55344, US

(21) Appl. No.: 11/675,291

(22) Filed: Feb. 15, 2007

(51) Int. Cl. F16J 15/02

(52) U.S. Cl. 277/312; 277/630

(57) ABSTRACT

A method and apparatus for forming a sealed joint between first and second construction surfaces comprises a joint spacer having a first state and a second state. In the first state, the joint spacer has a unitary structure which includes a first component and a second component, wherein in the first state the second component is engaged to the first component. In the second state the second component is disengaged from the first component. The joint spacer also has an adhesive disposed on at least a portion of only the first component, the adhesive configured to adhere to the first construction surface.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

Various embodiments of the present invention are directed to systems for maintaining and/or at least partially filling a space between two materials, particularly materials such as concrete, brick, stucco, plastic, wood, metal, and other somewhat rigid materials associated with construction and manufacturing. In some embodiments the invention is directed to joints, such as expansion joints, and more specifically to backings, fillers, forms, stand-offs, spacers and other devices suitable for insertion into the space between materials to form a joint, hereinafter referred to cumulatively as a spacer or joint spacer. In those embodiments directed to a joint spacer, the spacer comprises one or more components that are configured for placement into and/or removal from a joint space.

2. Description of the Related Art

Expansion joints and joints in general are present in many industrial applications. Typically a joint comprises a groove, trough or other space of selected shape and size between two surfaces or materials. Often the materials that define the space, such as concrete, wood, metal, plastic, etc. are often quite rigid. The space between these more rigid materials is at least partially filled with a joint spacer. The material of the joint spacer is typically less rigid than the surrounding materials. The joint spacer acts to maintain a space between the materials.

In many applications joint spaces are known to be formed by cutting into rigid materials or by forming the space through the utilization of rigid forming materials or standoffs. Once the joint space has been cut, or the forms removed, a flexible backer rod or other form is inserted into the space to a predetermined depth in order to obtain the desired joint shape and depth. After the backer rod is inserted, sealant is applied to finish the joint.

There are numerous disadvantages to cutting joint spaces in preparation for receiving a sealant. For example, in applications involving walls, it is difficult, if not impossible, to cut joint spaces adjacent to fenestrations or other wall penetrations in order to seal them to the surrounding material without damaging the frame or finish of the penetrating fixture in the cutting process. In addition, the cutting of joint spaces is expensive and difficult to do on vertical surfaces or from scaffolding. Furthermore, dust resulting from the cutting process may settle in the formed joint space. The dust may hinder sealant adhesion.

As mentioned above, as an alternative to cutting a joint space from the material, standoff type devices may be used to create the joint space. However, processes using forms and other standoff devices are also known to include drawbacks. For example, because standoffs are typically constructed of fairly rigid material that are put in place prior to the application of plastic construction materials, the forms often cannot be readily removed from the resulting joint space between the cured material without the destructive use of power tools or other equipment.

Often time standoffs are simply left in place within the joint space, however, because the standoff is made of rigid material that does not fill a substantial portion of the space, the standoff will not provide an insulating effect. Moreover, a standoff left in place may prevent the joint from opening and closing as intended, and may potentially lead to damage of the adjoining materials.

Known components that are inserted into the formed joint space, such as joint backer rods and other foam or semi-rigid materials are inserted into the joint space in order to establish a joint bottom and to provide a convex contour to the bottom of the joint space. As currently used however, backer rods and similar devices must be inserted into the joint space following placement of the materials adjacent to the space, or cutting of the space into the materials, but prior to the application of sealant. Almost without exception the backer rod or similar device is inserted into the space by the sealant contractor prior to application of the sealant. Often times during the insertion process the backer rod is punctured by the rough edges of the space or by the tools used to insert the rod. A punctured foam backer rod may emit gas which will cause bubbling in the plastic sealant. Another drawback to the use of backer rod is that it may be inserted at an inconsistent depth within the joint space. If this occurs, the joint sealant may fail prematurely because it was not placed at the desired depth-to-width ratio. In addition, expensive sealants may be wasted because the joint space is filled to a greater depth than desired.

In light of the above, it is clear that a need exists to provide a joint formation process and joint insertion material which avoids the drawbacks associated with those previously utilized.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided in order to comply with 37 C.F.R. § 1.72.

### BRIEF SUMMARY OF THE INVENTION

In at least one embodiment, the invention is directed to a joint spacer suitable for forming a sealed joint between a first construction surface and a second construction surface, the joint spacer having a first state and a second state. The joint spacer includes, in the first state, a unitary structure comprised of a first component and a second component, wherein in the first state the second component is engaged to the first component. In the second state, the second component is disengaged from the first component. The joint spacer further includes an adhesive disposed on at least a portion of only the first component, the adhesive configured to adhere to the first construction surface.

In some embodiments, the second component of the joint spacer has a predetermined length. In the first state, the unitary structure has at least one seam. In the first state, the second component is engaged to the first component along the at least one seam, the at least one seam extending along at least a portion of the predetermined length.

In at least one embodiment, the at least one seam comprises a first seam and a second seam. In the first state, the second component is engaged to the first component along both the first seam and the second seam along at least a portion of the predetermined length.

In some embodiments, both the first component and the second component have a top surface, a bottom surface, a first side, a second side, a portion of the top surface of the first component including a raised surface that extends toward the bottom surface of the second component.

In at least one embodiment, the raised surface includes a convex surface.

In some embodiments of the invention, a force applied to the second component at a non-zero angle relative to the length of the first component disengages the second component from the first component.

In at least one embodiment, the adhesive is disposed on at least a portion of at least one side of the first component.

In some embodiments, the adhesive is disposed on at least a portion of both the first side and the second side of the first component.

In at least one embodiment, in the first state the bottom surface of the second component and the top surface of the first component define a space therebetween.

In some embodiments, the space between the first component and the second component is largest at a point substantially equidistant from the first side and the second side.

In at least one embodiment, the first component includes a first component material, a first end, and a second end. The first component material defines a cavity extending longitudinally at least a portion of the length between the first end and the second end.

In some embodiments, the cavity is substantially equidistant between the first side, the second side, and the bottom surface.

In at least one embodiment, the invention is directed to a joint spacer suitable for forming a sealed joint between a window frame member and a wall material, the joint spacer having a first state and a second state. The joint spacer having, in the first state, a unitary structure having a first component and a second component, wherein in the first state the second component is engaged to the first component. In the second state, the second component is disengaged from the first component, wherein in the second state both the first component and the second component comprise a top surface, a bottom surface, a first side, a second side, and a predetermined length. In the second state, the first side of the first component and the top surface of the first component define a first top edge extending along the predetermined length. In the second state, the first side of the second component and the bottom surface of the second component define a first bottom edge extending along the predetermined length. In the second state, the second side of the first component and the top surface of the first component define a second top edge extending along the predetermined length. In the second state, the second side of the second component and the bottom side of the second component define a second bottom edge extending along the predetermined length. In the first state at least a portion of the first bottom edge of the second component is engaged to at least a portion of first top edge of the first component. The joint spacer further includes an adhesive disposed on at least a portion of the first component, the adhesive configured to adhere to the first construction surface.

In some embodiments, in the first state at least a portion of the second bottom edge of the second component is engaged to at least a portion of second top edge of the first component.

In at least one embodiment, at least one top edge of the first component is engaged to at least one bottom edge of the second component along the entire length of the first component.

In at least one embodiment, the invention is directed to a method of forming a joint spacer between a first construction surface and a second construction surface. The method includes the step of providing the first construction surface. Also, the method includes the step of providing the second construction surface. The method further includes the step of providing a joint spacer, the joint spacer having a first state and a second state. In the first state, the joint spacer includes a unitary structure having a first component and a second component. In the first state, the second component is engaged to the first component. In the second state, the second component is disengaged from the first component. The joint spacer further includes an adhesive disposed on at least a portion of only the first component, the adhesive configured to adhere to the first construction surface, and a material engaged to the adhesive so that the adhesive is covered prior to forming the joint. The method further includes the step of removing the material engaged to the adhesive. The method also includes the step of engaging the at least a portion of the first component with adhesive to the first construction surface. The method further includes the step of engaging the second construction surface to at least a portion of the first component. The method also includes the step of disengaging the second component from the first component.

In some embodiments the first component has a first side and a second side, the adhesive being disposed on at least a portion of both the first side and the second side. The step of engaging the at least a portion of the first component with adhesive to the first construction surface includes engaging at least a portion of the first side to the first construction surface, and the step of engaging the second construction surface to at least a portion of the first component includes engaging at least a portion of the second side to the second construction surface.

In at least one embodiment, the first construction surface is a window frame member and the second construction surface is a wall material.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawings.

FIG. 1 is a perspective view of an embodiment of the joint spacer of the present invention, showing a second component being disengaged from a first component.

FIG. 2 is a perspective view of an embodiment of the joint spacer of the present invention, showing a joint spacer in a first state.

FIG. 3 is a perspective view of an embodiment of the joint spacer of the present invention, showing a joint spacer in a second state.

FIG. 4 is a side view of the embodiment of the invention depicted in FIG. 1.

FIG. 5 is a front view of an embodiment of the invention, with the joint spacer engaged to first and second construction surfaces.

FIG. 6 is a side view of the first side of the embodiment depicted in FIG. 2.

FIG. 7 is a side view of the second side of the embodiment depicted in FIG. 2.

FIG. 8 is an end view of the embodiment depicted in FIG. 2.

FIG. 9 is an end view of the embodiment depicted in FIG. 3.

FIG. 10 is a flowchart of an embodiment of the present invention, depicting a method of forming a joint between two construction surfaces.

FIG. 11 is a front view of an embodiment of the invention, with the joint spacer engaged to first and second construction surfaces, and the second component still engaged to the first component.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

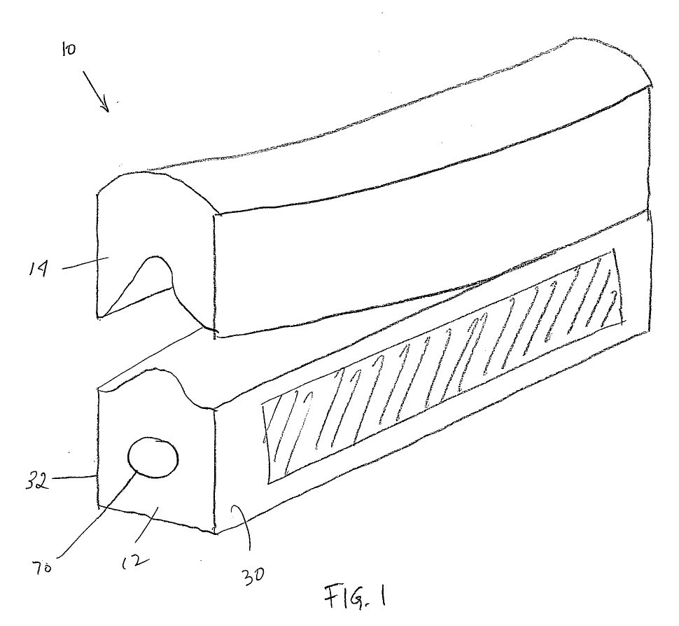

As indicated above, the present invention is directed to a variety of embodiments. A first embodiment is depicted in FIG. 1, wherein a joint spacer is shown generally at 10. The joint spacer 10 is comprised of a first component 12, a second component 14, and an adhesive 16.

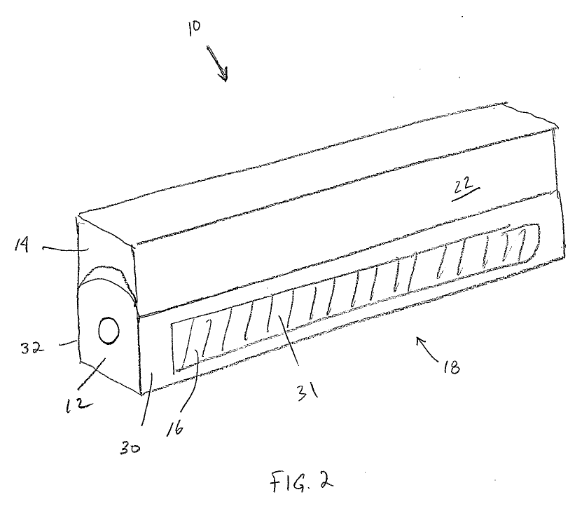

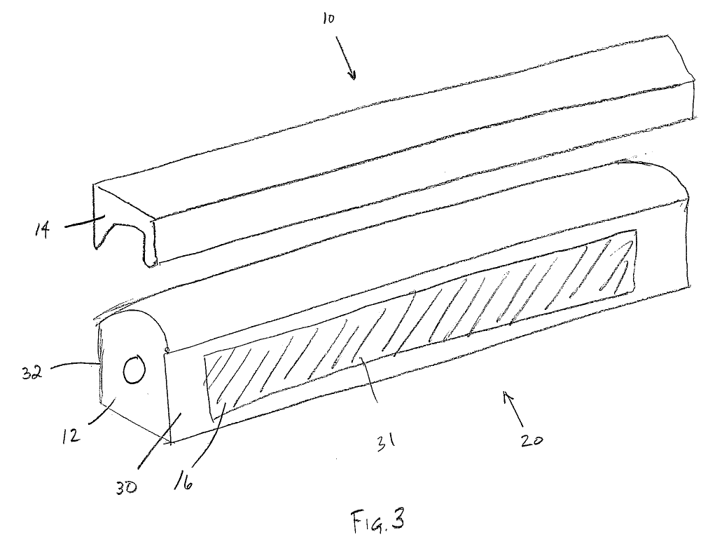

The joint spacer 10 has a first state shown generally at 18, as depicted in FIG. 2, and a second state, shown generally at 20, as depicted in FIG. 3. Referring now to FIG. 2, the joint spacer 10, in the first state, is a single or unitary structure 22. That is, the first component 12 is engaged to the second component 14 such that the two components form a unitary structure 22. The first component 12 and the second component 14 are formed as a unitary structure through injection molding or any other method known by those skilled in the art. In some embodiments, spacer 10 is formed by extrusion of flexible materials such as EPDM, foam rubber (natural or synthetic), polyethyelene, etc. In some embodiments the components 12 and 14 are co-extruded, such that each component is formed of a different material. Regardless of the material that the components are made from the nature of the extrusion process will cause the formed components to be provided with a temporary adhesion when they come into contact with each other as they exit the extruder head. This adhesion will further encourage separation of the components from their unitary state when the second component is removed from the first component in the intended environment of use.

As mentioned above, the joint spacer also has a second state 20, as best seen in FIG. 3. The second state 20 of the joint spacer 10 in FIG. 3 is characterized by the second component 14 being completely disengaged from the first component 12. FIG. 4 shows one way to transform the joint spacer 10 from the first state 18 in FIG. 2 to the second state 20 of FIG. 3: a force 24 is applied at a non-zero angle 26 relative to the length 28 of the first component 12. As seen in FIG. 4, the applied force 24 disengages the second component 14 from the first component 12 such that the unitary structure is separated into its constituent parts.

The joint spacer 10 further comprises an adhesive 16 disposed on the first component 12, as depicted in FIGS. 1-3. Because the second component will be later removed and discarded, it may be desirable to place the adhesive 16 only on the first component 12. Referring still to FIGS. 1-3, the adhesive 16 is shown disposed on a first side 30 of the first component 12. Although shown disposed on a portion of the first side 30, the adhesive 16 may be disposed on substantially all of the surface area of first side 30. Some embodiments of the present invention include a material 31 engaged to the adhesive so that the adhesive is covered prior to forming the joint. Just prior to engaging the adhesive to the construction surface, the material 31 is removed, exposing the adhesive, thus preventing any dust, dirt, or other particles or surfaces that would reduce the tack of the adhesive from contacting the adhesive.

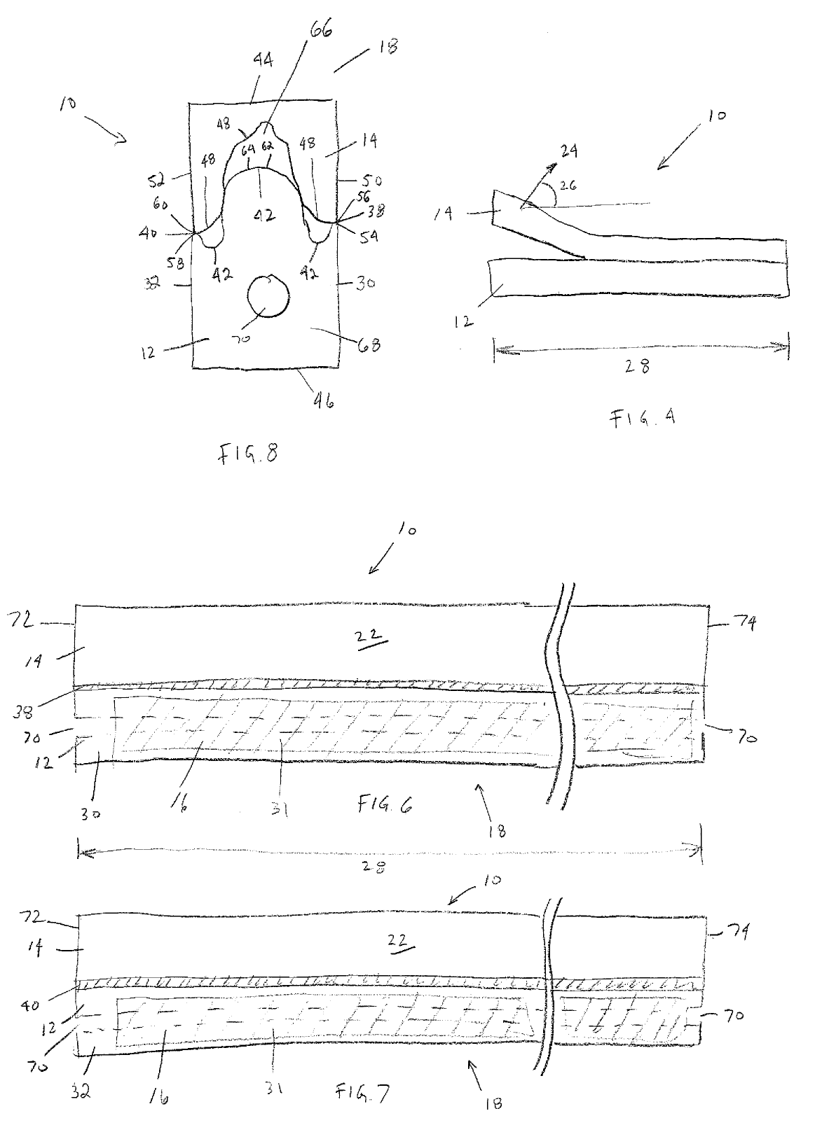

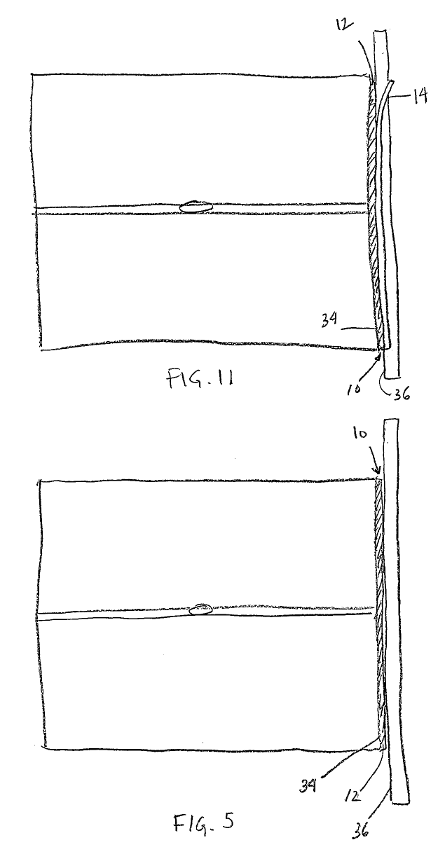

Furthermore, some embodiments of the joint spacer have adhesive 16 applied to both the first side 30 and the second side 32 of the first component 12. In such an embodiment, the adhesive on the first side of the first component can be engaged to a first construction surface 34 while the adhesive on the second side of the first component can be engaged to a second construction surface 36, as shown in FIG. 5.

Regarding the composition of the adhesive 16, it must be configured to adhere to both the joint spacer 10 and the desired construction surfaces. One of ordinary skill in the art will recognize that there are numerous adhesives that will adhere to both the joint spacer as well as construction surfaces.

In some embodiments of the present invention, the first component 12 and the second component 14 are engaged along a first seam 38, as depicted in the side view of FIG. 6. FIG. 6 shows the joint spacer 10 in its first state 18, and thus having its unitary structure 22, because of the first seam 18. The first seam 38 may extend along the entire length 28 of the first component 12, like in FIG. 6. Or, in some embodiments, the first seam may extend only a portion of the length of the first component. Referring now to FIG. 7, in at least one embodiment, the joint spacer 10 may include a second seam 40.

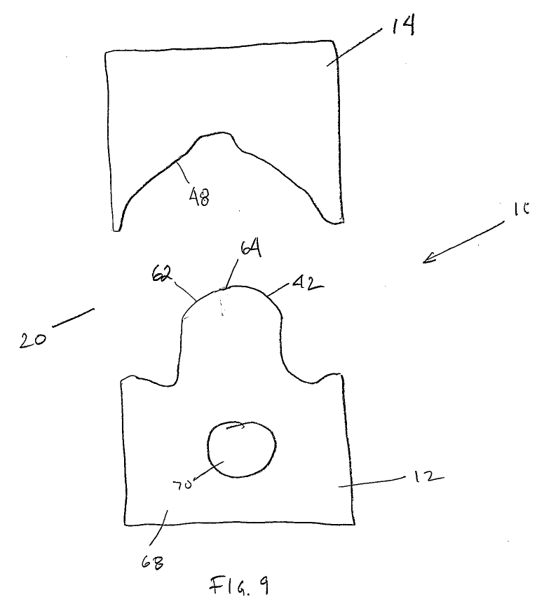

Seams 38 and 40 can best be seen in FIG. 8. FIG. 8 depicts an end view of the joint spacer 10 in its first state 18, with the first component 12 and the second component 14 engaged by the first seam 38 and the second seam 40. Although there are a number of methods for creating seams available to those skilled in the art, in FIG. 8 seams 38, 40 are formed from a thin quantity of material extending between the first component 12 and the second component 14. The presence and physical characteristics of such seams (thickness, etc.) are provided by the process of forming the joint spacer 10.

The first component 12 has a top surface 42, a bottom surface 46, and first and second sides 30, 32 respectively. The second component 14 has a top surface 44, a bottom surface 48, and first and second sides 50, 52 respectively. The top surface 42 and the first side 30 of the first component 12 define a first component first top edge 54. The bottom surface 48 and the first side 50 of the second component 14 define a second component first bottom edge 56. When the joint spacer 10 is in the first state, at least a portion of the first component first top edge 54 and at least a portion of the second component first bottom edge 56 are engaged to form the first seam 38.

As mentioned above, some embodiments of the present invention have a second seam 40. Still referring to FIG. 8, the top surface 42 and the second side 32 of the first component 12 define a first component second top edge 58. The bottom surface 48 and the second side 52 of the second component 14 define a second component second bottom edge 60. When the joint spacer 10 is in the first state, at least a portion of the first component second top edge 58 and at least a portion of the second component second bottom edge 60 are engaged to form the second seam 40.

In at least one embodiment of the present invention, at least one top edge of the first component is engaged to at least one bottom edge of the second component along the entire length of the first component.

It is important to note that the embodiments of the present invention are distinguished from the prior art in that in transforming the joint spacer 10 from the first state 18, as in FIG. 2, to the second state 20, as in FIG. 3, the second component 14 is torn from the first component 12. In at least some embodiments the adhesive 16 along side 30 of the first component 12 engages a first construction surface as described above. This engagement acts to anchor the first component 12, such that when a force 24 is applied to the second component 14, in the manner depicted in FIG. 4, the second component 14 will tear away from the first component 12 in a uniform and complete manner along the seam(s) 38 and/or 40 shown in FIG. 8. Force 22 can be any force sufficient to break the seams 38 and 40. An example of such a sufficient force is that which is applied by grasping the second component 14 by hand or hand-tool (pliers, etc) and pulling the second component 14 from the first component 12 at a non-zero angle as previously described.

The prior art, specifically U.S. Pat. No. 6,993,874 and U.S. Patent Application Publication No. 2006/0117692, the entire contents of each being incorporated herein by reference, suggests that “tearing” is undesirable in the use of joint formation. This is because the tearing of conventional backer rods may allow for non-uniform gas release from the torn cells of the polyurethane rod. This gas release may form bubbles or create pathways for air or water within the backer rod, thus compromising its insulating benefits.

While embodiments of the present invention provide that the second component is “torn” away from the first component, such tearing does not result in the formation of compromising pathways or trapped gas. As described above in reference to FIG. 4, the applied force tears the seam, or other engagement interface, that holds the two components together in the first state. While the prior art correctly recognizes the problems related to gas release upon tearing, in particular bubbling in the plastic sealant, embodiments of the present invention nevertheless avoid these problems despite tearing the foam material comprising the joint spacer. Embodiments of the present invention avoid these issues because of the manner in which the joint spacer is applied to the construction surfaces.

Here, the adhesive of the first component of the joint spacer is secured to a first construction surface, such as a window frame member, door frame member, or any number of other members commonly found in construction. The second component of the joint spacer is then torn away from the first component only after a second construction surface, such as stucco siding, vinyl siding, etc., is placed against or adjacent to the second side of the joint spacer.

Unlike previous backer rods and similar other prior art joint spacers, the nature of the inventive joint spacer described herein is such that when positioned between construction surfaces the joint spacer is not compressed. Thus, even when the second component is removed from the first component, any gas released from the separating seam(s) will be readily dissipated. Because the gas is not compressed and is allowed to dissipate, sealant placed upon the first component is undisturbed by trapped gas such as is often the case in the prior art.

Referring now to FIGS. 8 and 9, end views of an embodiment of the present invention are depicted. FIG. 9 shows the joint spacer 10 in the second state 20 wherein the first component 12 and the second component 14 are completely disengaged and a portion of the top surface 42 of the first component 12 has a raised surface 62. FIGS. 8 and 9 illustrate how the raised surface 62 extends toward the bottom surface 48 of the second component 14. In some embodiments, like in FIGS. 8 and 9, a portion of the raised surface comprises a convex surface 64.

As best seen in FIG. 8, in at least one embodiment of the present invention, the bottom surface 48 of the second component 14 and the top surface 42 of the first component 12 define a space 66 therebetween when the joint spacer 10 is in the first state 18. Still referring to FIG. 8, in some embodiments, the space 66 between the first component 12 and the second component 14 is largest at a point substantially equidistant from the first sides 30, 50 and second sides 32, 52 of the joint spacer.

In at least one embodiment, the first component 12 is formed from a first component material 68, as indicated in FIGS. 8 and 9. The first component material 68 defines a cavity 70 which extends between the first end 72 and the second end 74 longitudinally along the length 28 of the first component 12, as depicted in FIGS. 6 and 7. In some embodiments, like those depicted in FIGS. 6 and 7, the cavity is formed substantially equidistant from the first side 30, the second side 32, and the bottom side 46 of the first component 12. Although FIGS. 6 and 7 illustrate cavity 70 extending along the entire length 28 of the second component, it should be noted that the cavity 70 may only extend a portion of the length 28. The cavity may be formed only within the interior of the first component such that the cavity does not extend as far as either the first or second ends of the first component. In another embodiment, the cavity may be formed such that the cavity begins at one end of the first component, but does not extend the entire length to the other end.

In at least one embodiment the cavity 70 is constructed and arranged to act as a conduit for the receipt of grout, expandable foam, sealants, etc.

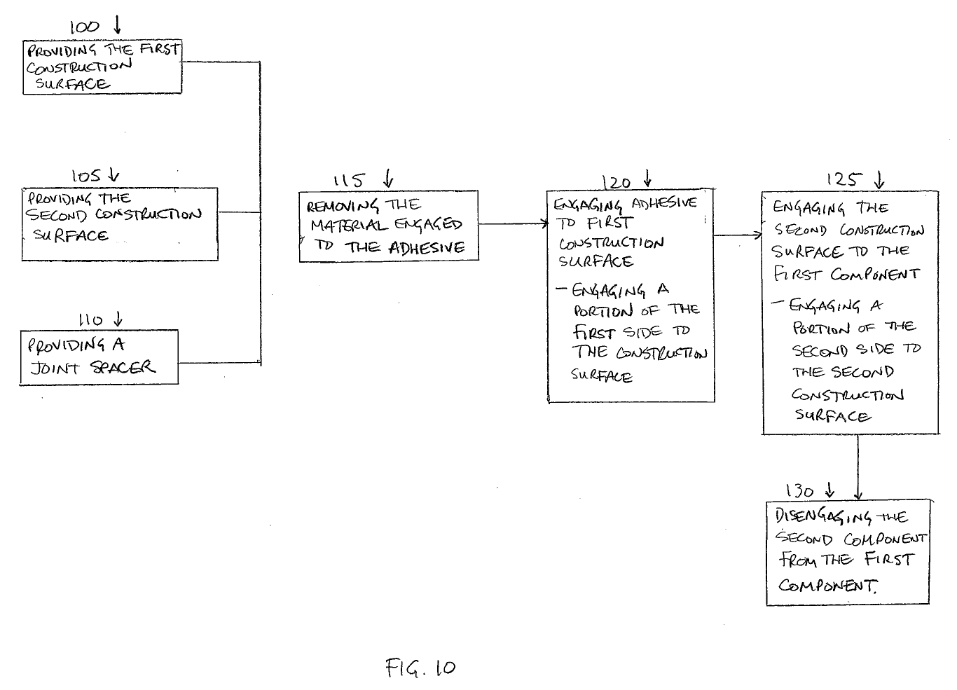

At least one embodiment of the present invention is directed towards a method of forming a joint between a first construction surface and a second construction surface, as shown in the flowchart in FIG. 10. The method comprises the step 100 of providing a first construction surface, the step 105 of providing a second construction surface, and the step 110 of providing a joint spacer.

As described above, the joint spacer has a first state and a second state. In the first state, the joint spacer has a unitary structure including a first component and a second component. The second component is engaged to the first component in the first state, and the second component is disengaged from the first component in the second state. An adhesive is disposed on at least a portion of only the first component, the adhesive configured to adhere to the first construction surface. A material, such as wax paper, etc. is also engaged to the adhesive so that the adhesive is covered prior to forming the joint.

The method further comprises the step 115 of removing the material engaged to the adhesive. After the material engaged to the adhesive has been removed, the method further comprises the step 120 of engaging the at least a portion of the first component with adhesive to the first construction surface. The method further comprises the step 125 of engaging the second construction surface to at least a portion of the first component and/or the second component. FIG. 11 is a front view of an embodiment of the invention, showing the first component 12 of joint spacer 10 engaged to both a first construction surface 34, depicted as a window frame member, and a second construction surface 36, depicted as wall material. As seen in FIG. 11, the first component 12 and the second component 14 are still engaged during step 125. Only after the second construction surface 36 is engaged to the first component 12 is the second component 14 disengaged from the first component 12, as detailed in method step 130.

In some embodiments of the present invention, wherein the first component has a first side and a second side and adhesive is disposed on at least a portion of both the first side and the second side, the method step 120 further includes the step of engaging at least a portion of the first side to the first construction surface and the method step 125 further includes engaging at least a portion of the second side to the second construction surface.

In at least one embodiment of the present invention, the first construction surface is a window frame member and the second construction surface is a wall material.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A joint spacer suitable for forming a sealed joint between a first construction surface and a second construction surface, the joint spacer having a first state and a second state, the joint spacer comprising:
in the first state, a unitary structure comprised of a first component and a second component, wherein in the first state the second component is engaged to the first component, and
in the second state, the second component is disengaged from the first component; and
an adhesive disposed on at least a portion of only the first component, the adhesive configured to adhere to the first construction surface.

2. The joint spacer of claim 1, wherein the first component has a predetermined length, and wherein in the first state, the unitary structure comprises at least one seam, and
wherein in the first state, the second component is engaged to the first component along the at least one seam, the at least one seam extending along at least a portion of the predetermined length.

3. The joint spacer of claim 2, wherein the at least one seam comprises a first seam and a second seam, and
wherein in the first state, the second component is engaged to the first component along both the first seam and the second seam along at least a portion of the predetermined length.

4. The joint spacer of claim 2, wherein both the first component and the second component comprise a top surface, a bottom surface, a first side, a second side, a portion of the top surface of the first component comprising a raised surface that extends toward the bottom surface of the second component.

5. The joint spacer of claim 4, wherein the raised surface comprises a convex surface.

6. The joint spacer of claim 2, wherein a force applied to the second component at a non-zero angle relative to the length of the first component disengages the second component from the first component.

7. The joint spacer of claim 2, wherein the adhesive is disposed on at least a portion of at least one side of the first component.

8. The joint spacer of claim 7, wherein the adhesive is disposed on at least a portion of both the first side and the second side of the first component.

9. The joint spacer of claim 2, wherein in the first state the bottom surface of the second component and the top surface of the first component define a space therebetween.

10. The joint spacer of claim 9 wherein the space between the first component and the second component is largest at a point substantially equidistant from the first side and the second side.

11. The joint spacer of claim 2, wherein the first component comprises a first component material, a first end, and a second end, the first component material defining a cavity extending longitudinally at least a portion of the length between the first end and the second end.

12. The joint spacer of claim 11, wherein the cavity is substantially equidistant from the first side, the second side, and the bottom surface.

13. A joint spacer suitable for forming a sealed joint between a window frame member and a wall material, the joint spacer having a first state and a second state, the joint spacer comprising:
in the first state, a unitary structure comprised of a first component and a second component, wherein in the first state the second component is engaged to the first component, and
in the second state, the second component being disengaged from the first component,
wherein in the second state both the first component and the second component comprise a top surface, a bottom surface, a first side, a second side, and a predetermined length, and
wherein the first side of the first component and the top surface of the first component define a first top edge extending along the predetermined length, and
wherein the first side of the second component and the bottom surface of the second component define a first bottom edge extending along the predetermined length, and
wherein the second side of the first component and the top surface of the first component define a second top edge extending along the predetermined length, and
wherein the second side of the second component and the bottom side of the second component define a second bottom edge extending along the predetermined length, and
wherein in the first state at least a portion of the first bottom edge of the second component is engaged to at least a portion of first top edge of the first component; and
an adhesive disposed on at least a portion of the first component, the adhesive configured to adhere to the first construction surface.

14. The joint spacer of claim 13, wherein in the first state at least a portion of the second bottom edge of the second component is engaged to at least a portion of second top edge of the first component.

15. The joint spacer of claim 13, wherein at least one top edge of the first component is engaged to at least one bottom edge of the second component along the entire length of the first component.

16. A method of forming a joint between a first construction surface and a second construction surface, the method comprising the steps of:
providing the first construction surface;
providing the second construction surface;
providing a joint spacer,
the joint spacer having a first state and a second state, in the first state the joint spacer comprising a unitary structure comprised of a first component and a second component, wherein in the first state the second component is engaged to the first component, and wherein in the second state the second component is disengaged from the first component, and
an adhesive disposed on at least a portion of only the first component, the adhesive configured to adhere to the first construction surface, and
a material engaged to the adhesive so that the adhesive is covered prior to forming the joint;
removing the material engaged to the adhesive;
engaging the at least a portion of the first component with adhesive to the first construction surface;
engaging the second construction surface to at least a portion of the first component; and
disengaging the second component from the first component.

17. The method of claim 16, wherein the first component has a first side and a second side, the adhesive being disposed on at least a portion of both the first side and the second side, and
wherein the step of engaging the at least a portion of the first component with adhesive to the first construction surface comprises engaging at least a portion of the first side to the first construction surface, and
wherein the step of engaging the second construction surface to at least a portion of the first component comprises engaging at least a portion of the second side to the second construction surface.

18. The method of claim 17, wherein the first construction surface is a window frame member and the second construction surface is a wall material.
